(19) United States
(12) Patent Application Publication
(10) Pub. No.: US 2022/0404915 A1
(43) Pub. Date: Dec. 22, 2022

(54) HUMAN COMPUTER INTERFACE SYSTEM THAT CORRECTS FOR SHAKY INPUT

(71) Applicant: Joshua D. Chapman, Santaquin, UT (US)

(72) Inventor: Joshua D. Chapman, Santaquin, UT (US)

(21) Appl. No.: 17/842,743

(22) Filed: Jun. 16, 2022

Related U.S. Application Data
(60) Provisional application No. 63/211,428, filed on Jun. 16, 2021.

(51) Int. Cl. G06F 3/01; G06F 3/04812; G06F 3/038

(52) U.S. Cl. CPC G06F 3/017; G06F 3/04812; G06F 3/038

(57) ABSTRACT

A human to computer interface system receives motion data from a motion sensor of the interface device, smooths the motion data to create control data, and outputs the control data to a computing device. The control data corrects for shakiness in manipulating the interface device and may be created by averaging the motion data of a time interval to result in smooth cursor movement on the display of the computing device.

### CROSS-REFERENCE TO RELATED APPLICATIONS

This application claims the benefit of U.S. Provisional Patent Application No. 63/211,428, filed Jun. 16, 2021, the contents of which are incorporated herein by reference in its entirety.

### BACKGROUND

Machine input devices vary widely from devices that control a cursor, to touch input, to others. A common human to computer interface device is a mouse, in which a user moves the input device with their hand and the movements are coordinated with an on-screen cursor device that allows the user to position the cursor at a desired portion of a display.

However, the traditional computer mouse is not suited to all users, especially those that have reduced mobility or precision in manipulating a human to computer interface device, such as a mouse.

It would be advantageous for a system that can receive input from a user experiencing reduced mobility or precision and provide an improved precision to the on-screen cursor.

These, and other, advantages will become readily apparent from the following description and accompanying drawings.

### SUMMARY

According to some embodiments, a computer input device includes one or more processors; memory coupled to the one or more processors; an optical sensor; and a smoothing algorithm executable by the one or more processors to cause the one or more processors to receive motion data captured by the optical sensor, smooth the motion data to create control data, and output the control data to a computing device. In some cases, a housing is provided that contains or encompasses the one or more processors, the memory, and the optical sensor. For example, the components of the entire computer input device may reside in a single house, which may resemble a computer mouse and the smoothing algorithm is implemented in the mouse device. In some cases, the computer input device is wireless and includes a wireless communication system to couple to a computer system to send control data. The wireless communication may be any suitable wireless communication, such as, for example, Bluetooth, Bluetooth low energy, Radio frequency, or otherwise.

In some examples, the smoothing algorithm is a Butterworth filter, and the filter may be implemented and/or executed within the computer input device. In some cases, a sensitivity adjustment control may be provided on the housing to allow a user to affect the sensitivity of how the smoothing algorithm is applied. For instance, a position of the sensitivity control may affect whether the smoothing algorithm uses a first order, second order, third order, fourth order, or higher order algorithm.

According to some embodiments, a method of smoothing motion data includes the steps of receiving, from a motion sensor within a computer input device, actual motion data of the computer input device; averaging, over a specified time interval, the actual motion data to create control data; and sending the control data to a computing device to control a cursor displayed by the computing device.

In some examples, the method includes the step of recalling, from a memory located within the computer input device, a correction setting. In some cases, the smoothing algorithm is an averaging algorithm or a Butterworth filter. The method may include establishing a wireless communication with a computer system prior to sending the control data. The method may further include adjusting the sensitivity of the filtering.

The result of the various embodiments is control data that approximate the input data, but the output data has been smoothed to allow for more precise control of a cursor displayed on a computer screen.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

FIG. 1 illustrates a block diagram showing the various systems and functions of a computer input device, in accordance with some embodiments;

FIG. 2 illustrates a process flow, in accordance with some embodiments; and

FIG. 3 illustrates a graph of a smoothing algorithm, in accordance with some embodiments.

### DETAILED DESCRIPTION

There are a large number of people that have difficulty interacting with a computer system because a traditional human to computer interface device does not account for frailties, illness, or degrading precision in manipulating the human to computer interface device. Some exemplary human to computer interface devices include, without limitation, a computer mouse, a track ball, a touch pad, a stylus, a touch screen, and the like. For convenience throughout the description, a computer mouse will be used as a non-limiting example and it should be appreciated that the systems and methods described herein are applicable to any of a number of human to computer interface devices, such as those mentioned above.

For example, individuals that suffer from Parkinson's, Essential tremor, Multiple Sclerosis, medication side effects, Wilson's disease, as well as other chronic illnesses may experience shaky hands and/or arms when attempting to manipulate a computer mouse. A typical mouse will receive the shakiness as an input, and correspondingly, the on-screen cursor will shake in response to shaky manipulation of the mouse.

According to some embodiments, a system and device are provided that will attenuate, dampen, smooth, interpolate, and/or clean the input to the computer to allow smooth and/or precise inputs. In other words, through the described hardware and software, a shaky input to a mouse may result in a smooth traversal of the on-screen cursor, which may increase precision when positioning a cursor on a display device.

According to some embodiments, a computer mouse includes one or more momentary push buttons, a rotary encoder, and in some cases, an optical sensor. Some embodiments additionally include a microchip with integrated USB interface. Some examples include two or more momentary push buttons and/or a slide switch to control the functioning of the smoothing capability. Some embodiments may include one or more LEDS, such as for providing light for the optical sensor, indicate power to the mouse, or to indicate a status of the smoothing circuitry.

In addition to the traditional inputs that one might find on a typical computer mouse, some embodiments additionally include a correction algorithm that receives the actual input to the mouse, and outputs the average movement over the course of a specified time. In some cases, the specified time may be encoded in hardware or software or may be determined by the user, such as by manipulating a software or hardware sensitivity control. The sensitivity control may be stored within the device, such as within memory associated with the device.

According to some example embodiments, the systems and/or methods described herein may be under the control of one or more processors. The one or more processors may have access to computer-readable storage media (“CRSM”), which may be any available physical media accessible by the processor(s) to execute instruction stored on the CRSM and may be non-transitory computer readable storage media. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other medium which can be used to store the desired information and which can be accessed by the processor(s).

In some cases, first, second, third and fourth order digital filters based on the Butterworth filter governing equations may be used to smooth the data. A Butterworth filter is a type of signal processing filter that has a frequency response that is maximally flat in the passband. The degree to which the data is smoothed can be controlled by changing the order of the filter and the cutoff frequency. The governing equations may be based, at least in part, on the Transfer Function form to ABCD matrix and state vector form to allow for numerical processing of the data. This filter may be applied to X and Y directions of motion, scroll wheel input and button input. The output of these filters may be sent as an input from the human to computer interface device. The state-space representation is a mathematical model of a physical system represented as a set of input, output, and state variables related by first-order differential or difference equations. The state space is the Euclidean space in which the variables on the axes are the state variables. The state of the system can thus be represented as a state vector within that space, which lends itself to approximating the motion of a computer input device, such as a mouse, a touch screen, a smart pen, a track ball, a roller ball, or some other manually manipulated human to computer interface device. After receiving the output from the filters as an input, the computer then moves a cursor on a display that is associated with the filtered motion of the mouse and may be displayed as a smooth moving cursor despite the shaky input initially received by the mouse.

The mouse may be wired to the computer, such as by a USB cable, or any other now known or future developed technology that supports wired connections. In some cases, the mouse connects to the computer wirelessly, such as through any suitable wireless communication protocol, such as radio frequency, Bluetooth, Bluetooth low energy, among others.

According to some embodiments, the hardware and software required for sending the smoothed input to the computer are contained within the mouse. In other words, the smoothing functionality of the mouse is fully contained within the mouse and the mouse is “plug and play” to any of a variety of computers, without the need for extra hardware or software installed onto the computer.

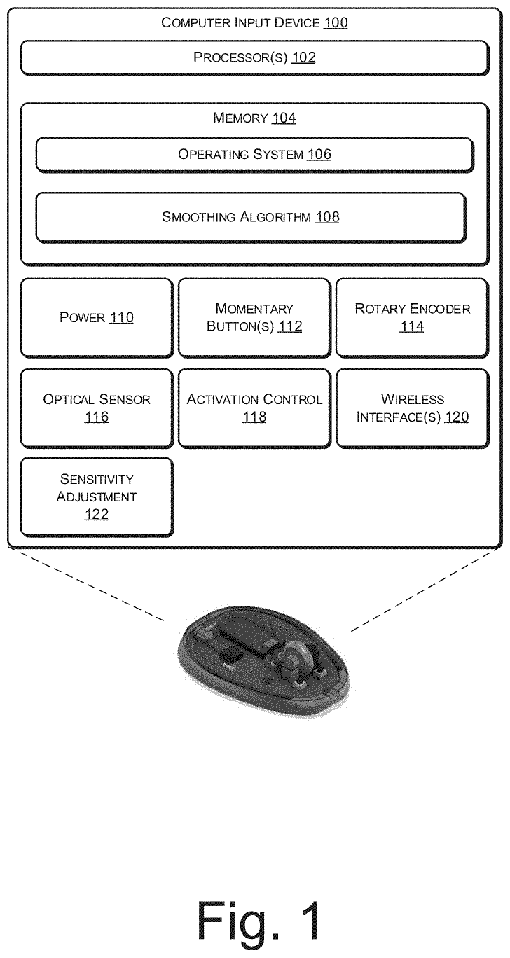

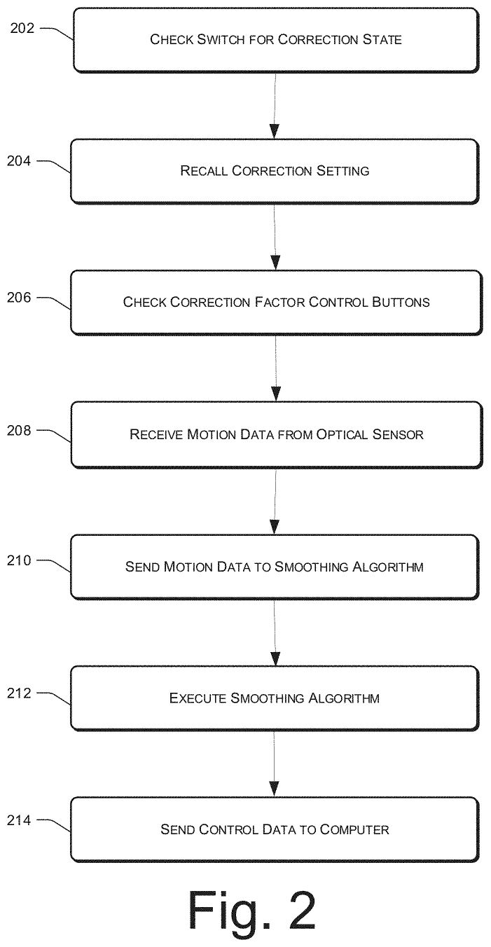

With reference to FIG. 1, a computer input device 100 is shown that is capable of correcting the input to account for shakiness. The device includes one or more processors 102 and memory 104 in communication with the processors. The memory stores instructions that, when executed by the one or more processors, cause the processors to perform acts. In some embodiments, the acts performed by the processors include acts illustrated in FIG. 2. At a high level, the acts include receiving motion data, smoothing the motion data, and outputting control data to the computer.

The memory 104 may include an operating system 106 and one or more smoothing algorithms 108. In some embodiments, the smoothing algorithm 108 is configured to provide time-averaged motion data. The time-averaged motion data may be provided by tracking motion over a predetermined period of time, such as 0.25 seconds, 0.5 seconds, 1 second, 2 seconds, 3 seconds, or more. The motion data may be aggregated by time-bound constraints and the motion within the time-bound constraints may be averaged during the time-bound constraint to result in an average movement during the time-bound constraint. As an example, a user with a shaky hand may attempt to move the mouse in a downward vertical motion; however, due to the shakiness of the user's hand, the actual motion of the mouse may be erratic and include many side to side movements in addition to moving downward vertically. Where the time-bound constraint includes horizontal motion to the left and the right, those motions may be averaged, and in some cases, will cancel each other out. Accordingly, the computer input device 100 may send control data to the computer that resembles a downward vertical motion.

According to some embodiments, the motion inputs are converted to a digital signal and run through an algorithm. The algorithm receives an input, generates a charge variable, and generates an output that corresponds with an average motion of the computer input device 100.

For example, a fraction of the difference between the input and the charge variable may be subtracted from the input and added to the charge variable. The result may be generated as the output.

According to some embodiments, a correction factor may be used within a smoothing algorithm. A motion input may be converted to a digital signal associated with the motion input. A charge variable is generated, and the charge variable and the motion input may be divided by the correction factor, which may provide a compensation or may be used to determine the magnitude of the compensation.

As an output, the smoothing algorithm 108 may then take the input and subtract the compensation to generate an output. Optionally, a new charge variable may be generated by adding the compensation to the previous charge variable. The smoothing algorithm 108 decreases the lag time needed to make the correction. In some examples, the smoothing algorithm 108 may be a combination of two or more algorithms, that may combine to reduce latency as well as filter out noise from the motion input to generate a smoothed output with reduced latency.

The smoothing algorithm 108 thus receives actual motion data and outputs smoothed control data to the computer, such as for controlling an on-screen cursor.

The computer input device 100 may also include a power system 110, which may be provided by one or more batteries as is known in the art. One or more momentary buttons 112 allow the user to provide additional input, as is known in the field of computer input devices. A rotary encoder 114 may be provided, such as a scroll wheel. In some cases, the actual movement data of the rotary encoder 114 may also be sent to the smoothing algorithm and control data associated with the rotary encoder 114 may be averaged, or otherwise smoothed, and sent to the computer as control data.

The computer input device 100 may further include an optical sensor 116, such as may be used to detect movement of the mouse. Of course, other types of sensors may be used to capture motion of a computer input device, such as for example, a trackball input, a stylus input, a touch screen input, a tablet input, and the like.

An activation control 118 may be provided to allow a user to turn on or off the smoothing algorithm functionality. This allows multiple individuals to use the computer input device 100 and decide whether or not to have the smoothing functionality active. A wireless interface 120 may be provided to allow the computer input device 100 to communicate with one or more computer devices. The wireless interface may allow the device 100 to communicate with any of a number of computing devices, such as, a desktop computer, laptop computer, tablet computer, smart phone, smart watch, gaming system, smart television, set top box, and other computing devices to which the device 100 may provide an input.

A sensitivity adjustment 122 may be provided on the device 100, such as by providing push buttons that allow a user to increase or decrease sensitivity. In some cases, a slider is provided to adjust sensitivity. The sensitivity adjustment 122 may be provided in any suitable location, such as on the top of the device, on the side of the device, or on the bottom of the device, for example.

With reference to FIG. 2, in some cases, the device 100 may be in a low power state during which time many of the features may be turned off. Upon detecting movement of the device, it may wake up and provide power to all of the features within the device. At a first block 202, the device may check the switch for the correction state. For example, the device 100 may self-check to determine whether the smoothing functionality is active or has been temporarily deactivated.

At block 204, the correction setting may be recalled. In some cases, a correction setting may be input to the device and stored within memory for later recall.

At block 206, the device 100 may check to determine whether the correction factor has been activated on the device and adjust the factor according to input.

At block 208, the device 100 receives motion data from the optical sensor that is associated with movement of the device 100.

At block 210, the motion data is sent to the smoothing algorithm and, at block 212, the smoothing algorithm is executed on the motion data. The motion data may be sent in time-bound segments of motion data or may be sent to the smoothing algorithm as continuous motion data and the smoothing algorithm averages the motion data of a set time-bound period.

At block 214, the device 100 sends control data to the computer. In some embodiments, the control data is the smoothed motion data such that a jerky motion input is smoothed and sent to the computer as control data that results in a smooth traversal of a cursor in a direction and speed intended by the user.

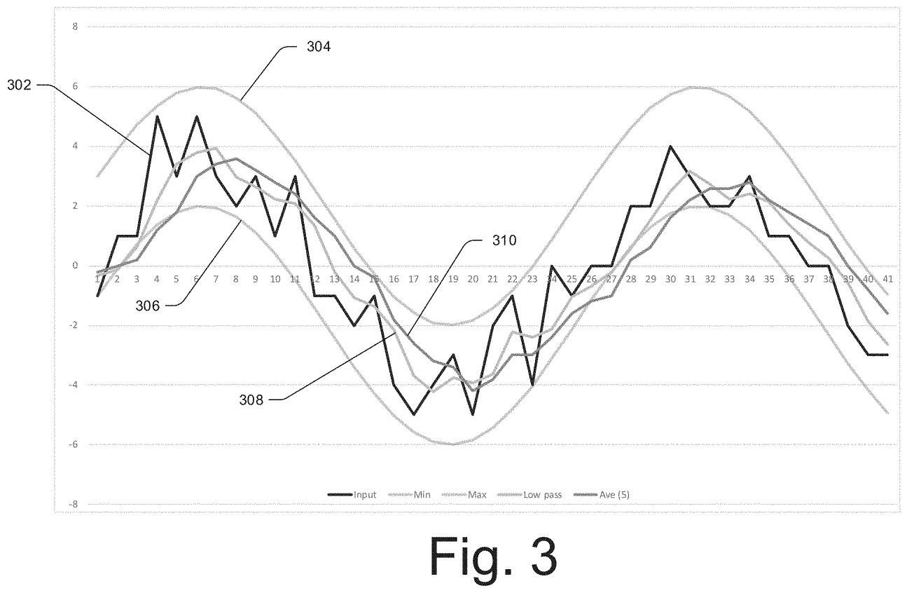

FIG. 3 illustrates a graph showing various outputs from a low-pass smoothing algorithm and an averaging algorithm.

An input curve 302 represents raw motion input of the device 100. As can be seen, the raw motion may be shaky and not smooth, which typically would be displayed on a computer screen as similarly shaky. The raw input may have a maximum 304 and a minimum 306, which provide upper and lower bounds for the output after executing one or more smoothing algorithms. A low pass algorithm 308, which may function similarly to a low-pass filter on an electrical circuit and as described herein, may smooth the raw input to create an output in which the shakiness has been reduced, or smoothed. Additionally, or alternatively, an averaging algorithm 310 may also be applied to the input 302, as described herein, to smooth the input into an output that results in smoother cursor movement on a display screen.

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The specification and annexed drawings disclose examples of systems, apparatus, devices, and techniques that may provide smoothing of motion data to allow a shaky input to be smoothed and increase precision. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

Those skilled in the art will appreciate that, in some implementations, the functionality provided by the processes and systems discussed above may be provided in alternative ways, such as being split among more software programs or routines or consolidated into fewer programs or routines. Similarly, in some implementations, illustrated processes and systems may provide more or less functionality than is described, such as when other illustrated processes instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other implementations the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some implementations, illustrated data structures may store more or less information than is described, such as when other illustrated data structures instead lack or include such information respectively, or when the amount or types of information that is stored is altered. The various methods and systems as illustrated in the figures and described herein represent example implementations. The methods and systems may be implemented in software, hardware, or a combination thereof in other implementations. Similarly, the order of any method may be changed and various elements may be added, reordered, combined, omitted, modified, etc., in other implementations.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A computer input device, comprising:
one or more processors;
memory coupled to the one or more processors;
an optical sensor; and
a smoothing algorithm executable by the one or more processors to cause the one or more processors to receive motion data captured by the optical sensor, smooth the motion data to create control data, and output the control data to a computing device.

2. The computer input device as in claim 1, further comprising a housing encompassing the one or more processors, the memory, and the optical sensor.

3. The computer input device as in claim 1, further comprising a wireless communication system and the computer input device is configured to wirelessly connect to a computer system as an input device to the computer system.

4. The computer input device as in claim 1, wherein the smoothing algorithm is a Butterworth filter.

5. The computer input device as in claim 1, wherein the smoothing algorithm is executed within the computer input device.

6. The computer input device as in claim 1, further comprising a sensitivity adjustment control that is configured to impact application of the smoothing algorithm. The computer input device as in claim 1, comprising a mouse.

8. A method of smoothing motion data, comprising:
receiving, from a motion sensor within a computer input device, actual motion data of the computer input device;
filtering the actual motion data by applying a series of state variables and governing equations to create control data; and
sending the control data to a computing device to control a cursor displayed by the computing device.

9. The method of claim 8, further comprising recalling, from a memory located within the computer input device, a correction setting.

10. The method of claim 8, wherein the filtering comprises averaging, over a specified time interval, the actual motion data to create the control data.

11. The method of claim 8, wherein the filtering comprises executing a Butterworth filter within the computer input device.

12. The method of claim 8, further comprising establishing a communication between the computer input device and the computing device.

13. The method of claim 7, wherein the communication is a wireless communication.

14. The method of claim 8, further comprising adjusting a sensitivity of the filtering.
